(19) United States
(12) Patent Application Publication
(10) Pub. No.: US 2021/0073854 A1
(43) Pub. Date: Mar. 11, 2021

(54) DETERMINING BLACKOUT PERIOD FOR PRODUCT RECOMMENDATIONS

(71) Applicant: PayPal, Inc., San Jose, CA (US)

(72) Inventors: Zexi Mao, San Jose, CA (US); Rohan Kekatpure, San Jose, CA (US); William DeRose, San Jose, CA (US); Xincheng Lai, San Jose, CA (US)

(21) Appl. No.: 16/565,459

(22) Filed: Sep. 9, 2019

(51) Int. Cl. G06Q 30/02

(52) U.S. Cl. CPC G06Q 30/0246; G06Q 30/0247

(57) ABSTRACT

In response to detecting a purchase of a first product by a user, a computer system determines a category of the first product. In response to determining the category of the first product, the computer system determines a blackout time period for the user based on a maximum revenue impact amount corresponding to the blackout time period, a probability that the first product will be repurchased, and a probability that the first product is purchased after an impression is viewed, and wherein the blackout time period corresponds to a time period where one or more impressions of at least the first product purchased by the user are not transmitted for display to the user. In response to determining the blackout time period for the user, the computer system causes the blackout time period to be applied to the user.

### TECHNICAL FIELD

The present disclosure relates to product recommendations, and more particularly to determining blackout periods for product recommendations.

### BACKGROUND

The payments landscape has changed drastically over the past decade. This is primarily due to financial technology and e-commerce platforms that allow consumers to have simple and frictionless shopping experiences online, while also allowing consumers to transfer money to their family and friends via their computers and mobile devices. Furthermore, these platforms may create further engagement with customers by providing product recommendations to their customers based on analyzing user data and identifying products/items that a customer may be interested in (such as based on past transactional activity). However, if product recommendations are provided too frequently, a platform may risk turning off a customer.

### BRIEF DESCRIPTION OF THE DRAWINGS

FIG. 1 illustrates a blackout system, in accordance with an embodiment.

FIG. 2 is a flowchart illustrating the operations of the blackout application of FIG. 1 in detecting a purchase and determining an appropriate blackout time period in response to detecting the purchase, in accordance with an embodiment.

FIG. 3 is a depiction of a first embodiment of a Markov chain model with one or more blackout states, in accordance with an embodiment.

FIG. 4 is a depiction of a second embodiment of a Markov chain model with one or more blackout states, in accordance with an embodiment.

FIG. 5 is a depiction of third embodiment of a Markov chain model with one or more blackout states, in accordance with an embodiment.

FIG. 6 is a block diagram depicting the hardware components of the blackout system of FIG. 1, in accordance with an embodiment.

### DETAILED DESCRIPTION

Embodiments of the present disclosure provide a system, method, and program product.

In the example embodiment, in response to detecting a purchase of a first product by a user, a computer system determines a category of the first product. In response to determining the category of the first product, the computer system determines a blackout time period for the user based on a maximum revenue impact amount corresponding to the blackout time period, a probability that the first product will be repurchased, and a probability that the first product is purchased after an impression is viewed, and wherein the blackout time period corresponds to a time period where one or more impressions of at least the first product purchased by the user are not transmitted for display to the user. In response to determining the blackout time period for the user, the computer system causes the blackout time period to be applied to the user.

In other embodiments, in response to detecting a purchase of a first product by a user, a computer system determines a category of the first product. In response to determining the category of the first product, the computer system determines a blackout time period for the user based on a maximum revenue impact amount corresponding to the blackout time period, a probability that the first product will be repurchased, a probability that the first product is purchased after an impression is viewed, and a number of products that correspond to the category of the first product, and wherein the blackout time period corresponds to a time period where one or more impressions of at least the first product purchased by the user are not transmitted for display to the user. In response to determining the blackout time period for the user, the computer system causes the blackout time period to be applied to the user.

In further embodiments, in response to detecting a purchase of a first product by a user, a computer system determines a category of the first product. In response to determining the category of the first product, the computer system determines a blackout time period for the user based on a maximum revenue impact amount corresponding to the blackout time period, a probability that the first product will be repurchased, a probability that the first product is purchased after an impression is viewed, and a probability that an impression for the first product has been provided to the user, and wherein the blackout time period corresponds to a time period where one or more impressions of at least the first product purchased by the user are not transmitted for display to the user. In response to determining the blackout time period for the user, the computer system causes the blackout time period to be applied to the user.

As stated above, product recommendations to a customer need to be sensitive to the price and longevity of the historical purchases of the customer. Providing recommendations of recently purchased products can put a damper on the customer experience and, in some cases, drive the customer away. Providing a blackout, a duration of time where certain recommendations are not provided to the customer (or are suppressed), can be an effective solution to this problem. However, a blackout period for a product (or category of products) that is too long can lead to a loss in repurchase revenue as well as a bad customer experience (too few recommendations may cause a customer to have to spend time searching for products). The present disclosure describes a system and method for determining an appropriate blackout period in response to detecting a purchase of a product/item by a user that has occurred after an impression has been served to the user. In the example embodiment, an impression may be an advertisement, notification, or a similar ad-focused message.

Embodiments of the present disclosure will now be described in detail with reference to the accompanying Figures.

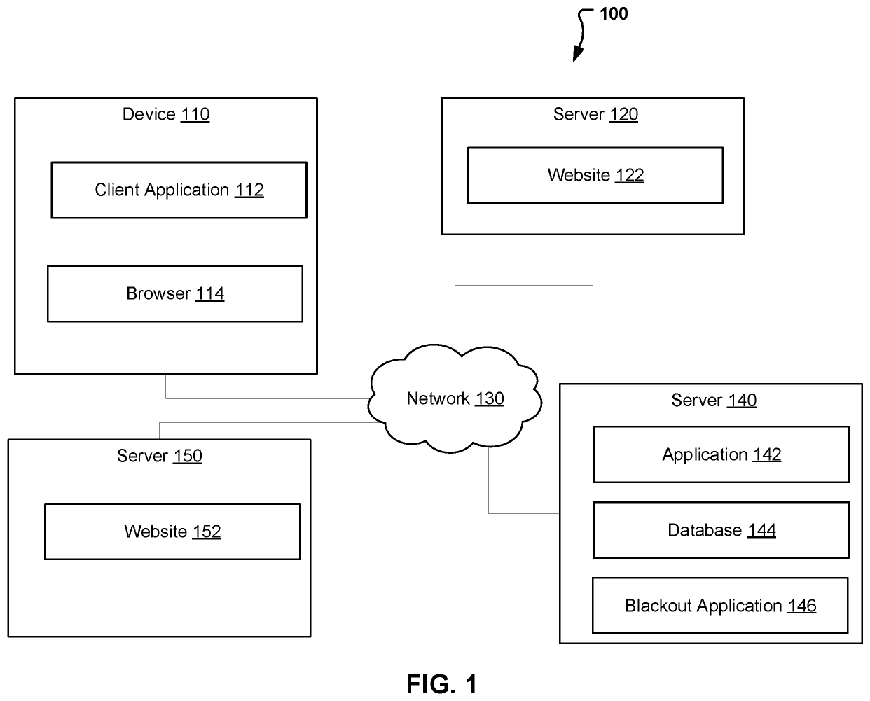

FIG. 1 illustrates blackout system 100, in accordance with an embodiment. In the example embodiment, blackout system 100 includes device 110, server 120, server 140, and server 150 interconnected via network 130.

In the example embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a Bluetooth network, a local area network (LAN), or a wide area network (WAN). In general, network 130 can be any combination of connections and protocols that will support communications between computing devices, such as between device 110 and server 140.

In the example embodiment, server 120 includes website 122. In the example embodiment, server 120 is a server of a merchant or a service provider, however, in other embodiments, server 120 may correspond to a different type of entity. In the example embodiment, server 120 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 120 can comprise a cluster of servers executing the same software to collectively process requests as distributed by a front-end server and a load balancer. In the example embodiment, server 120 is a computing device that is optimized for the support of websites that reside on server 120, such as website 122, and for the support of network requests related to websites, which reside on server 120. Server 120 is described in more detail with regard to the figures.

In the example embodiment, website 122 is a collection of files including, for example, HTML files, CSS files, image files and JavaScript files. Website 122 may also include other resource files such as audio files and video files. In the example embodiment, website 122 is a merchant or service provider website, however, in other embodiments, website 122 may be another type of website. Website 122 is described in more detail with regard to the figures.

In the example embodiment, server 150 includes website 152. In the example embodiment, server 150 is a server of a merchant or a service provider, however, in other embodiments, server 150 may correspond to a different type of entity. In the example embodiment, server 150 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 150 can comprise a cluster of servers executing the same software to collectively process requests as distributed by a front-end server and a load balancer. In the example embodiment, server 150 is a computing device that is optimized for the support of websites that reside on server 150, such as website 152, and for the support of network requests related to websites, which reside on server 150. Server 150 is described in more detail with regard to the figures.

In the example embodiment, website 152 is a collection of files including, for example, HTML files, CSS files, image files and JavaScript files. Website 152 may also include other resource files such as audio files and video files. In the example embodiment, website 152 is a merchant or service provider website, however, in other embodiments, website 152 may be another type of website. Website 152 is described in more detail with regard to the figures.

In the example embodiment, device 110 includes client application 112 and browser 114. In the example embodiment, device 110 may be a desktop computer, a laptop computer, a tablet computer, a mobile device, a handheld device, a thin client, or any other electronic device or computing system capable of receiving and sending data to and from other computing devices, such as server 140, via network 130. Device 110 is described in more detail with regard to the figures.

In the example embodiment, client application 112 is a client-side application, corresponding to the server-side application 142, that is capable of transmitting requests to application 142 and is further capable of providing received information to a user of device 110 via a user interface. Client application 112 is described in more detail with regard to the figures.

In the example embodiment, browser 114 is an application that is capable of communicating with other computing devices to transmit request and a receive information. Furthermore, browser 114 is capable of displaying received information to the user of device 110. In the example embodiment, browser 114 may transmit a request to a website, such as website 122, and further receive webpage information from website 122. Browser 114 is described in further detail with regard to the figures.

In the example embodiment, server 140 includes application 142, database 144, and blackout application 146. In the example embodiment, server 140 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 140 can comprise a cluster of servers executing the same software to collectively process requests as distributed by a front-end server and a load balancer. In the example embodiment, server 140 is a computing device that is optimized for the support of applications that reside on server 140, such as application 142, and for the support of network requests related to application 142. Server 140 is described in more detail with regard to the figures.

In the example embodiment, database 144 includes information corresponding to a mapping between one or more products and one or more categories. In the example embodiment, there may be a separate mapping corresponding to each individual merchant (or for a group of merchants, such as merchants within the same space, i.e., home improvement, etc.), however, in other embodiments, an overall mapping may be maintained between one or more products and one or more categories across all merchants. In the example embodiment, a “product” may correspond to a particular product (or stock keeping unit (SKU)), and a category may correspond to all products (such as all SKUs) pertaining to a type of product. For example, a product may be a lawnmower created by a first manufacturer, while the corresponding category may be all lawnmowers (created by the first manufacturer or a plurality of manufacturers). In the example embodiment, merchants may provide a category associated with each product to the service provider associated with application 142. Application 142 may then compile the information provided by the merchants in database 144. Database 144 is described in more detail with regard to the figures.

In the example embodiment, application 142 is a server-side application, corresponding to the client-side applications such as client application 112. While in the example embodiment, application 142 may be a payment application, in other embodiments, application 142 (and the corresponding client applications) may be a social media application, an e-commerce application, or a different type of application. In the example embodiment, application 142 is capable of receiving information from client applications and further capable of responding to requests from corresponding client applications. Furthermore, in the example embodiment, application 142 is capable of providing one or more impressions to the user of device 110 (such as via client application 112). In addition, application 142 may be capable of facilitating a purchase of a product, such as a product corresponding to the one or more impressions provided to the user of device 110. Application 142 is described in further detail with regard to the figures.

In the example embodiment, blackout application 146 is an application that is capable of detecting a purchase of a product made by a user, where the purchase occurs after an impression of the product has been provided to the user by application 142. Furthermore, blackout application 146 is capable of determining a category corresponding to the product, and further determining an appropriate blackout period to associate with the user. In addition, in the example embodiment, blackout application 146 may transmit a signal to application 142 to cause the determined appropriate blackout period to be implemented. In the example embodiment, blackout application 146 is a stand-alone application, however, in other embodiments, blackout application 146 may be partially or fully integrated with application 142. Blackout application 146 is described in more detail with regard to the figures.

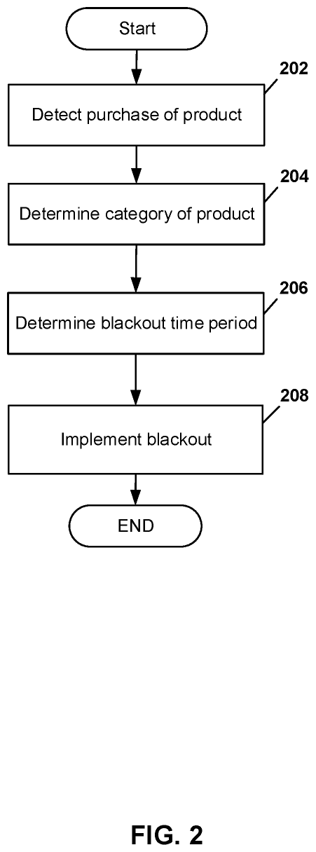

FIG. 2 is a flowchart illustrating the operations of blackout application 146 in detecting a purchase and determining an appropriate blackout time period in response to detecting the purchase, in accordance with an embodiment. In the example embodiment, blackout application 146 may detect the purchase of a product by a user of device 110 (step 202). In the example embodiment, blackout application 146 may detect the purchase of the product by way of communication with application 142 (and client application 112). For example, a user of device 110 may utilize client application 112 to initialize a purchase of the product (which may be completed or processed by application 142). Therefore, blackout application 146 may, via communication with application 142, detect the purchase of the product. In another example, the user of device 110 may utilize browser 114 to access website 122 (or website 152) to purchase a product being offered by the merchant or service provider associated with website 122. Furthermore, the user of device 110 may be a user of a payment service provider associated with application 142, and further may utilize the payment service provider to process the purchase of the product. In this example, blackout application 146 may also detect the purchase via communication with application 142. In a further example, the same process may be performed to make an in-app purchase (utilizing the payment service provider), and blackout application 146 may once again detect the purchase via communication with blackout application 142.

In the example embodiment, blackout application 146 may monitor user activity and transaction activity occurring on application 142, however, in other embodiments, application 142 may transmit transactional information to blackout application 146 for evaluation.

In the example embodiment, blackout application 146 may determine a category corresponding to the purchased product (step 204). In the example embodiment, as stated above, database 144 may maintain a mapping between one or more products and one or more corresponding categories across one or more merchants. Therefore, blackout application 146 may access database 144 and determine a category (or categories) that corresponds to the purchased product. Furthermore, by way of referencing database 144, blackout application 144 may determine a number of total products that correspond to the identified category (or each of the categories if the purchased product corresponds to multiple categories).

In the example embodiment, blackout application 146 determines an appropriate blackout period for the user of device 110 (step 206). In the example embodiment, a blackout may be determined and applied to a specific product that has been purchased by the user of device 110, all the products within the category corresponding to the specific product that has been purchased by the user of device 110, or a portion of the products within the category corresponding to the specific product that has been purchased by the user of device 110. These are all discussed in further detail below:

### Category Level Blackout

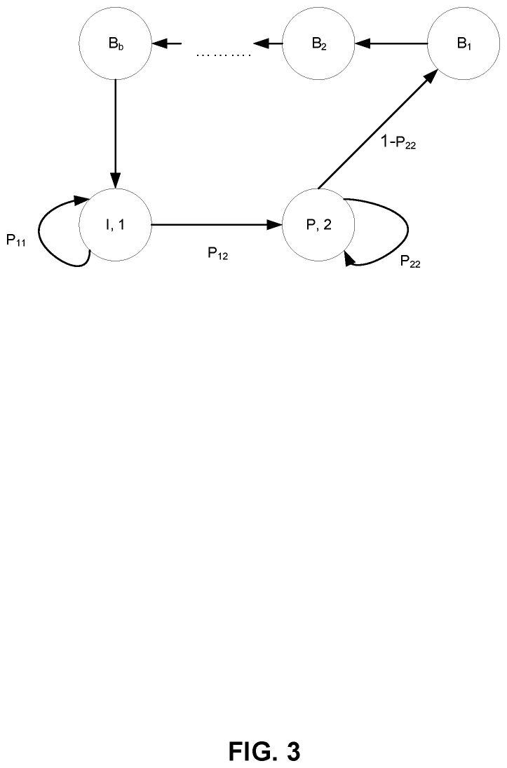

In the example embodiment, FIG. 3 depicts of a first embodiment of a Markov chain model with one or more blackout states, in accordance with an embodiment. In the example embodiment, with FIG. 3 depicts a Markov chain that corresponds to a system where blackout application 146 determines a blackout period and applies the blackout period to all products of the category that corresponds to the product purchased by the user of device 110. In the example embodiment, state “I, 1” represents a state where a user is provided with an impression, such as an advertisement for a product, state “P,2” represents a state where a user has made a purchase of the product, and states “B₁, B₂ . . . B_{b}” represent one or more blackout states the comprise a blackout time period. In the example embodiment, P₁₁ represents the probability that a user stays at the impression stage after being served an impression (i.e., no purchase is made after viewing the impression), P₁₂ represents the probability that a user makes a purchase after viewing (being served) an impression, P₂₂ represents the probability that a user makes another purchase while in state “P,2” without being served an impression (such as a repurchase), and 1−P₂₂ represents the probability that a user has been moved to a blackout state after purchase of a product (that corresponds to an impression served to the user).

In the example embodiment, as stated above, the corresponding steady-state vector for this Markov chain can be denoted as π′=[π′ᵢ, π′ₚ, d₁ . . . d_{b}], where π′ᵢ and π′ₚ are the new fractional populations in state I and P, and d_{1 . . . b} are the fractional populations in the B blackout states. The steady-state population distribution with blackout π′ can be obtained by solving π′=π′P′, subject to Σⱼπ′ⱼ=1, which in component form reads:

π′ᵢ=p₁₁π′ᵢ+d_{b}

π′ₚ=p₁₂π′ᵢ+p₂₂π′ₚ

d₁=(1−p₂₂)π′ₚ

dₖ₊₁=dₖ for k=2, . . . , b−1

π′ᵢ+π′ₚ+Σₖ₌₁^{b}dₖ=1 (normalization) (1)

In the example embodiment, this leads to the following solution to π′ₚ:

$${π}_{p}^{′} = \frac{1}{1 + ( 1 - {p}_{22} ) ( b + \frac{1}{{p}_{12}} )} \qquad ( 2 )$$

As stated above, implementing a blackout for a product (in which impressions for the product will not be served to a user) may have an impact on revenue (due to potentially less purchases from the user). Therefore, in an effort to limit the impact, a variable α may be utilized, which represents a maximum percentage impact to revenue that would be tolerated by a service provider, such as the service provider associated with application 142. For example, if a service provider wants to limit the maximum percentage impact to 2%, α may equal 0.02. In the example embodiment, the revenue impact variable α states that the decrease in π′ₚ will be no greater than α, and therefore, π′ₚ≥(1−α)πₚ. This may be utilized to determine an equation for the maximum allowable blackout duration (represented by the variable “b”) as shown below by Equation 3:

$$b \leq \frac{α}{1 - α} \cdot \frac{1}{1 - {p}_{22}} \cdot ( 1 + \frac{1 - {p}_{22}}{{p}_{12}} ) \qquad ( 3 )$$

In the example embodiment, this equation may be utilized to determine an appropriate blackout time period for the user of device 110. The variable α may be determined based on the desired maximum revenue impact, as described above, which may be determined by the service provider associated with application 142. For example, as stated above, if the desired maximum revenue impact is 2%, then α would equal 0.02. As stated above, the variable P₁₂ represents the probability that a user makes a purchase after viewing (being served) an impression, and the variable P₂₂ represents the probability that a user makes another purchase while in state “P,2” without being served an impression (such as a repurchase). In the example embodiment, blackout application 146 may determine the probability values for these variables based on analyzing historical purchase/repurchase and impression information. For example, for the specific product purchased by the user of device 110, blackout application 146 may analyze impressions that were served and purchases of the specific product that were made after the impressions were served, as well as repurchases of the product made by without an impression being served in order to identify probabilities corresponding to each of these variables. Once the values are determined for the variables α, P₁₂, and P₂₂, blackout application 146 may utilize equation (3) shown above to identify a maximum blackout period for the user of device 110 with regard to the specific product. In the example embodiment, blackout application 146 may apply the determined maximum blackout time period to all products within the identified category that corresponds to the product purchased by the user of device 110 (category level blackout).

In other embodiments, blackout application 146 may determine a specific blackout time period for each product within the identified category by utilizing equation (3) and determining values for the variables P₁₂ and P₂₂, for each product within the identified category based on the historical purchase/repurchase and impression information of each corresponding product. In further embodiments, blackout application 146 may apply the determined blackout period to a subset of products that corresponds to the identified category (blackout period may be determined based on historical information corresponding to the purchased product or based on historical information corresponding to each respective product). In one or more embodiments, the subset of products may be identified at random or may be identified based on a similarity coefficient. For example, 4 products of 10 products in the category may be identified for blackout based on a similarity coefficient of the 4 products being above a certain threshold level (or based on the 4 products having the highest similarity coefficient when compared to the purchased product).

In additional embodiments, blackout application 146 may determine a specific blackout time period for a subset of products or all products within the identified category by determining values for the variables P₁₂ and P₂₂, based on historical purchase/repurchase and impression information corresponding to the entire category of products as a whole, and then utilizing equation (3) to determine a blackout time period to apply to the subset or entire category.

### Product Level Blackout

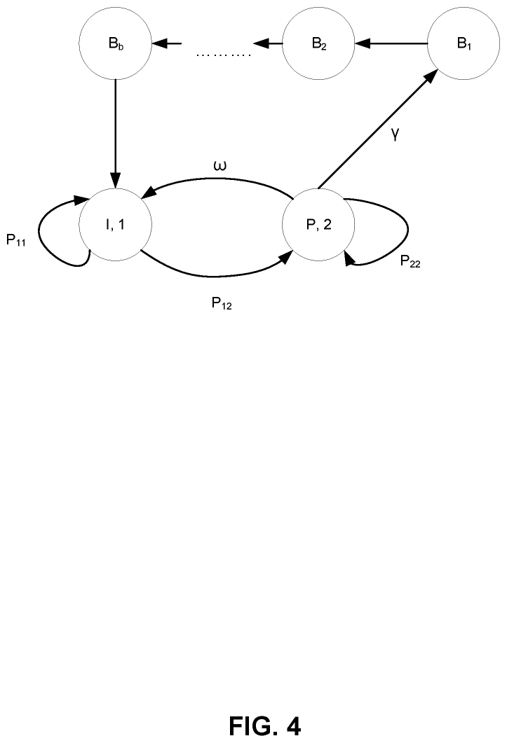

In the example embodiment, FIG. 4 depicts of a second embodiment of a Markov chain model with one or more blackout states, in accordance with an embodiment. In the example embodiment, with FIG. 4 depicts a Markov chain that corresponds to a system where blackout application 146 determines a blackout period and applies the blackout period with respect to the product that was purchased by the user of device 110, rather than applying the blackout time period to the entire category corresponding to the product purchased by the user of device 110. In the example embodiment, state “I, 1” represents a state where a user is provided with an impression, such as an advertisement for a product, state “P,2” represents a state where a user has made a purchase of the product, and states “B₁, B₂ . . . B_{b}” represent one or more blackout states the comprise a blackout time period. In the example embodiment, P₁₁ represents the probability that a user stays at the impression stage after being served an impression (i.e., no purchase is made after viewing the impression), P₁₂ represents the probability that a user makes a purchase after viewing (being served) an impression, P₂₂ represents the probability that a user makes another purchase while in state “P,2” without being served an impression (such as a repurchase), and γ represents the probability that a user has been moved to a blackout state after purchase of a product (that corresponds to an impression served to the user). Furthermore, ω represents the probability that the user is returned by blackout application 146 to the impression state (I) from P. In the example embodiment, with regard to the embodiment described in this Figure, if there are n distinct products within the category corresponding to the product purchased by the user of device 110, then blackout application 146 can model the situation by making γ=1/n, and therefore, creating a 1/n, probability that a user experiences a blackout with respect to the products of the category corresponding to the product purchased by the user of device 110. Furthermore, in the example embodiment, if γ=1/n, this results in ω=1−γ−P₂₂.

In the example embodiment, this leads to the following solution to π′ₚ:

$${π}_{p}^{′} = \frac{1}{1 + ( 1 - {p}_{22} ) ( γ b + \frac{1}{{p}_{12}} )} \qquad ( 4 )$$

Furthermore, this results in the maximum allowable blackout duration equaling:

$$b \leq \frac{1}{γ} \cdot \frac{α}{1 - α} \cdot ( 1 + \frac{1 - {p}_{22}}{{p}_{12}} ) \qquad ( 5 )$$

In the example embodiment, this equation (Equation 5) may be utilized to determine an appropriate blackout time period for the user of device 110. The variable α may be determined based on the desired maximum revenue impact, as described above, which may be determined by the service provider associated with application 142. For example, as stated above, if the desired maximum revenue impact is 2%, then α would equal 0.02. In addition, as stated above, for this embodiment, γ=1/n, with n representing the number of products in the category that corresponds to the product that was purchased by the user of device 110. Furthermore, as stated above, the variable P₁₂ represents the probability that a user makes a purchase after viewing (being served) an impression, and the variable P₂₂ represents the probability that a user makes another purchase while in state “P,2” without being served an impression (such as a repurchase). In the example embodiment, blackout application 146 may determine the probability values for these variables based on analyzing historical purchase/repurchase and impression information. For example, for the specific product purchased by the user of device 110, blackout application 146 may analyze impressions that were served and purchases of the specific product that were made after the impressions were served, as well as repurchases of the product made by without an impression being served in order to determine probability values corresponding to each of these variables. Once the values are identified for the variables α, γ, P₁₂, and P₂₂, blackout application 146 may utilize equation (5) shown above to identify a maximum blackout period for the user of device 110 with regard to the specific product. In the example embodiment, blackout application 146 may apply the determined maximum blackout time period to the specific product that was purchased by the user of device 110 (product level blackout).

In other embodiments, blackouts application 146 may apply the determined maximum blackout time period to all products within the identified category that corresponds to the product purchased by the user of device 110 (category level blackout).

In further embodiments, blackout application 146 may determine a specific blackout time period for each product within the identified category by utilizing equation (5) and determining values for the variables P₁₂ and P₂₂, for each product within the identified category based on the historical purchase/repurchase and impression information of each corresponding product. In further embodiments, blackout application 146 may apply the determined blackout period to a subset of products that corresponds to the identified category (blackout period may be determined based on historical information corresponding to the purchased product or based on historical information corresponding to each respective product). In one or more embodiments, the subset of products may be identified at random or may be identified based on a similarity coefficient in a similar manner as described above.

In additional embodiments, blackout application 146 may determine a specific blackout time period for a subset of products or all products within the identified category by determining values for variables P₁₂ and P₂₂, based on historical purchase/repurchase and impression information corresponding to the entire category of products as a whole, and then utilizing equation (5) to determine a blackout time period to apply to the subset or entire category.

Product Level Blackout Accounting for Blackout related Impression/Purchase Reductions

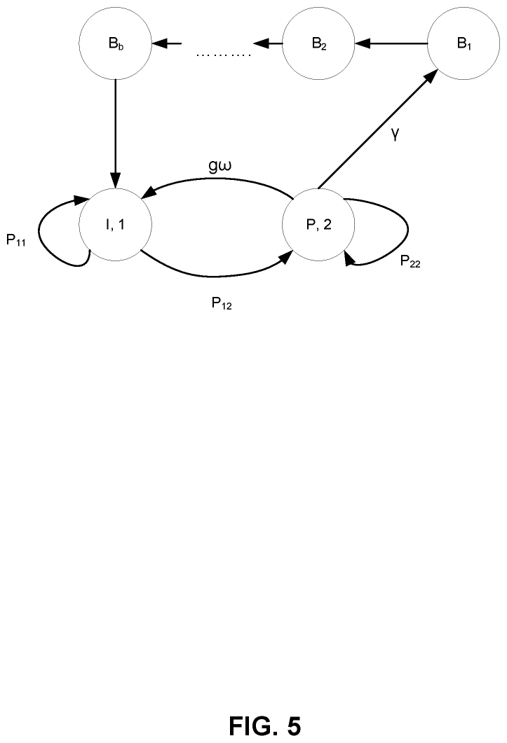

In the example embodiment, FIG. 5 depicts of a third embodiment of a Markov chain model with one or more blackout states, in accordance with an embodiment. In the example embodiment, with FIG. 5 depicts a Markov chain that corresponds to a system where blackout application 146 determines a blackout period and applies the blackout period with respect to the product that was purchased by the user of device 110, while utilizing estimating techniques to determine y. In the example embodiment as stated above, state “I, 1” represents a state where a user is provided with an impression, such as an advertisement for a product, state “P,2” represents a state where a user has made a purchase of the product, and states “B₁, B₂ . . . B_{b}” represent one or more blackout states the comprise a blackout time period. In the example embodiment, P₁₁ represents the probability that a user stays at the impression stage after being served an impression (i.e., no purchase is made after viewing the impression), P₁₂ represents the probability that a user makes a purchase after viewing (being served) an impression, P₂₂ represents the probability that a user makes another purchase while in state “P,2” without being served an impression (such as a repurchase), and γ represents the probability that a user has been moved to a blackout state after purchase of a product (that corresponds to an impression served to the user). Furthermore, gω represents the probability that the user is returned by blackout application 146 to the impression state (I) from P.

In the example embodiment, implementing a blackout for one or more users results in a reduced overall number of impressions being viewed by users which may in turn result in a decrease in the number of purchases. In the example embodiment, the effect of implementing a blackout on one or more users may be broken down into two variables: vᵢ and uᵢ. The variable vᵢ represents the probability that an impression for product i has been provided (or viewed) by a user. The variable uᵢ represents the probability that a product i has been purchased (after viewing an impression). In the example embodiment, popular products will have a high value for u and v.

In the example embodiment, calculating and implementing a reduction factor g within the Markov model may help account for the reduced overall number of a reduced overall number of impressions being viewed by users (and decrease in purchases) that may occur due to the implementation of a blackout. In the example embodiment, if at time t, a user made a purchase, the user may then be barred from seeing impressions for the product that was purchased. In other words, if the user purchases a product i (probability uᵢ), the probability that the user will see an impression for the category corresponding to the purchased product in the next time step may be represented by gω, with the calculation of the reduction factor g being represented by:

g=Σᵢuᵢ(1−vᵢ)=1−Σᵢuᵢvᵢ (6)

In the example embodiment, referring to Markov chain, we can determine that the probability that a user has been moved to a blackout state after purchase of a product (γ) plus the probability that user repurchases (P₂₂) plus the probability that the user will see an impression for the category corresponding to the purchase (gω), i.e., moved from state P to state I is equal to 1. In other words:

γ+gw+P₂₂=1 (7)

Solving for γ leads to the equation 8 shown below:

γ=(1−g)(1−P₂₂) (8)

In the example embodiment, if we plug in this value for γ into Equation 5, we obtain a maximum allowable blackout duration represented by:

$$b \leq \frac{α}{1 - α} \cdot \frac{1}{( 1 - g )} \cdot ( \frac{1}{{P}_{21}} + \frac{1}{{p}_{12}} ) \qquad ( 9 )$$

In the example embodiment, Equation 9 is based off the assumption that P₂₁+P₂₂=1. In the example embodiment, this assumption is made based off the assumption that the percentage flowing into a blackout state is a small perturbation on the system, and therefore, the Pᵢⱼ values remain the same. Utilizing Equation 12 on datasets gives blackout durations that show the correct trend (from ordering as well as a ratio perspective), however, the resulting blackout durations may be in some cases too long in an absolute value sense. Therefore, converting γ to a logarithmic scale yields blackout durations that preserve relative ordering between categories as well as providing a more accurate scale/magnitude. In other words, referring to Equation 9, we may replace 1/(1−g) with log (1/(1−g)) as shown below:

$$b \leq \frac{α}{1 - α} \cdot log ( \frac{1}{( 1 - g )} ) \cdot ( \frac{1}{{P}_{21}} + \frac{1}{{p}_{12}} ) \qquad ( 10 )$$

In the example embodiment, Equation 10 may be utilized to determine an appropriate blackout time period for the user of device 110. As stated above, the variable α may be determined based on the desired maximum revenue impact, as described above, which may be determined by the service provider associated with application 142. For example, as stated above, if the desired maximum revenue impact is 2%, then α would equal 0.02. In addition, in the example embodiment P₂₁ represents the probability that the user will see an impression for the category corresponding to the purchased product in the next time step. Furthermore, as stated above, the variable P₁₂ represents the probability that a user makes a purchase after viewing (being served) an impression. In the example embodiment, blackout application 146 may determine the probability values for these variables based on analyzing historical purchase/repurchase and impression information. For example, for the specific product purchased by the user of device 110, blackout application 146 may analyze impressions that were served and purchases of the specific product that were made after the impressions were served, as well as repurchases of the product made by without an impression being served in order to determine probability values corresponding to each of these variables. Once the values are identified for the variables α, g (utilizing the equation above), P₁₂, and P₂₁, blackout application 146 may utilize equation (10) shown above to identify a maximum blackout period for the user of device 110 with regard to the specific product. In the example embodiment, blackout application 146 may apply the determined maximum blackout time period to the specific product that was purchased by the user of device 110 (product level blackout).

In other embodiments, blackouts application 146 may apply the determined maximum blackout time period to all products within the identified category that corresponds to the product purchased by the user of device 110 (category level blackout).

In further embodiments, blackout application 146 may determine a specific blackout time period for each product within the identified category by utilizing equation (10) and determining values for the variables P₁₂ and P₂₁, for each product within the identified category based on the historical purchase/repurchase and impression information of each corresponding product. In further embodiments, blackout application 146 may apply the determined blackout period to a subset of products that corresponds to the identified category (blackout period may be determined based on historical information corresponding to the purchased product or based on historical information corresponding to each respective product). In one or more embodiments, the subset of products may be identified at random or may be identified based on a similarity coefficient in a similar manner as described above.

In additional embodiments, blackout application 146 may determine a specific blackout time period for a subset of products or all products within the identified category by determining values for variables P₁₂ and P₂₁, based on historical purchase/repurchase and impression information corresponding to the entire category of products as a whole, and then utilizing equation (10) to determine a blackout time period to apply to the subset or entire category.

In the example embodiment, the above described a few different methodologies that may be utilized by blackout application 146 to determine a maximum blackout duration. In the example embodiment, once blackout application 146 determines an appropriate blackout period for the user of device 110, blackout application 146 may implement the determined blackout period with respect to the user of device 110 (step 208). In the example embodiment, as stated above, the blackout may be implemented with respect to an entire category corresponding to the specific product purchased by the user of device 110, the specific product purchased by the user of device 110, or a subset of the category. Furthermore, in the example embodiment, implementing the blackout may include transmitting a message/signal to application 142 to cause application 142 to implement the determined blackout.

### Utilizing Estimating Techniques to Determine Values for Transition Probability Matrix

Furthermore, in one or more embodiments, estimating techniques may be utilized to determine the probability values of the transition probability matrix (i.e., P₁₁, P₁₂, P₂₁, P₂₂, etc.). These techniques may be utilized in conjunction with any of the techniques described above (with respect to determining a maximum blackout time period). In these one or more embodiments, we can fix our time step to a specific time period and compute variables G_{I}^{t}, G_{II}^{t+1}, G_{IP}^{t+1}, G_{IB}^{t+1}, and G_{IB}^{t+2}. In these one or more embodiments, G_{I}^{t} represents the number of users that received an impression (I) at time t, while G_{II}^{t+1} represents the number of users from G_{I}^{t} that did not make a purchase by time t+1. Furthermore, G_{IP}^{t+1} represents the number of users from G_{I}^{t} that made a purchase by time t+1, G_{IB}^{t+1} represents the number of users that go directly from impression to blackout (which in these one or more embodiments is zero), and G_{IB}^{t+2} represents the number of users from G_{I}^{t} that made a purchase by time t+2 but did not see an impression for that purchase.

Therefore, utilizing these variables, we can determine the probability values of the transition probability matrix. For example, P₁₁=G_{II}^{t+1}/G_{I}^{t}, and P₁₂=G_{IP}^{t+1}/G_{I}^{t}. Furthermore, with regard to time step t, if we utilize a time step value of 30 days (which may be another time period in other embodiments), and use a sliding window over the time period of available data (for example, a year has approximately 330 30 day windows), we can obtain different estimates for each of the probability values ((i.e., P₁₁, P₁₂, P₂₁, P₂₂, etc.). These estimates are the probability distributions of the respective probability values, from which a maximum-likelihood estimation may be determined.

Furthermore, in one or more embodiments, blackout application 146 may construct a transition probability matrix that corresponds to a specific segment of a population (such as segments that are based on demography, geography, type of job, user-activity, etc.). In addition, a transition probability matrix may be constructed to be specific to a certain merchant or a merchant type. For example, with respect to hardware stores, some of their customers may work as professional contractors, and therefore, may exhibit different re-purchase, purchase habits than non-contractor customers. Therefore, the data corresponding to these two groups may be split into segments, with the data corresponding to each segment being fit into a Markov Chain model (and a specific transition probability matrix being constructed), as described above. Therefore, with respect to a detected user purchase, user information may be analyzed to determine if the user fits into a specific segment (such as based on a job type). Furthermore, if the user corresponds to a specific segment, the appropriate Markov Chain model/transition probability matrix may be utilized to determine a blackout time period for the user.

The foregoing description of various embodiments of the present disclosure has been presented for purposes of illustration and description. It is not intended to be exhaustive nor to limit the disclosure to the precise form disclosed. Many modifications and variations are possible. Such modifications and variations that may be apparent to a person skilled in the art of the disclosure are intended to be included within the scope of the disclosure as defined by the accompanying claims.

Furthermore, this specification includes references to “the example embodiment,” “other embodiments,” “one or more embodiments, “further embodiments”, “additional embodiments”, and the like. The appearances of these phrases do not necessarily refer to the same embodiment. Particular features, structures, or characteristics may be combined in any suitable manner consistent with this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features.

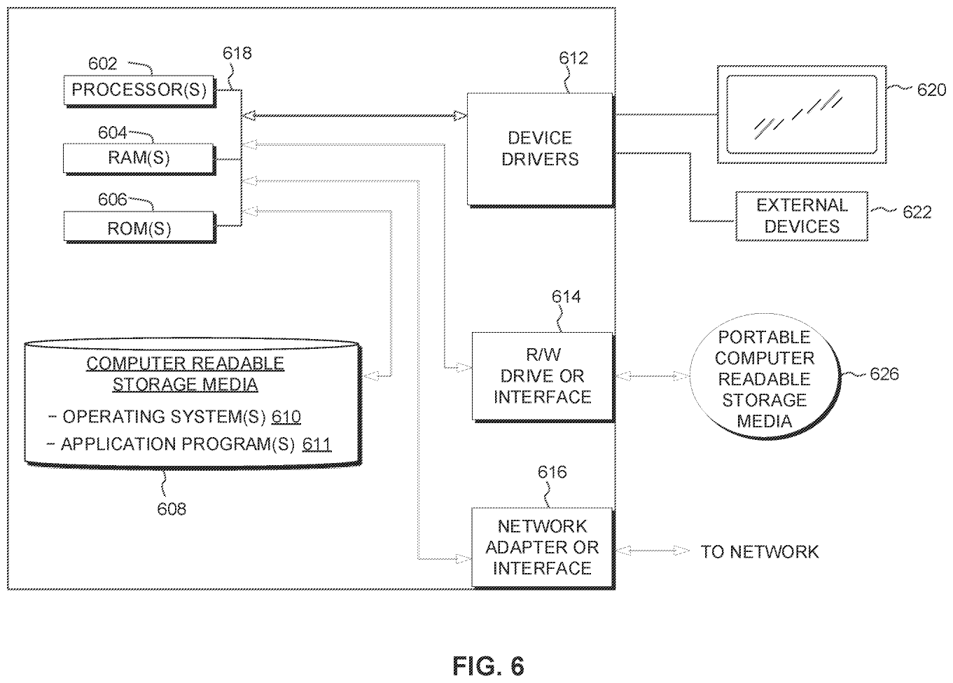

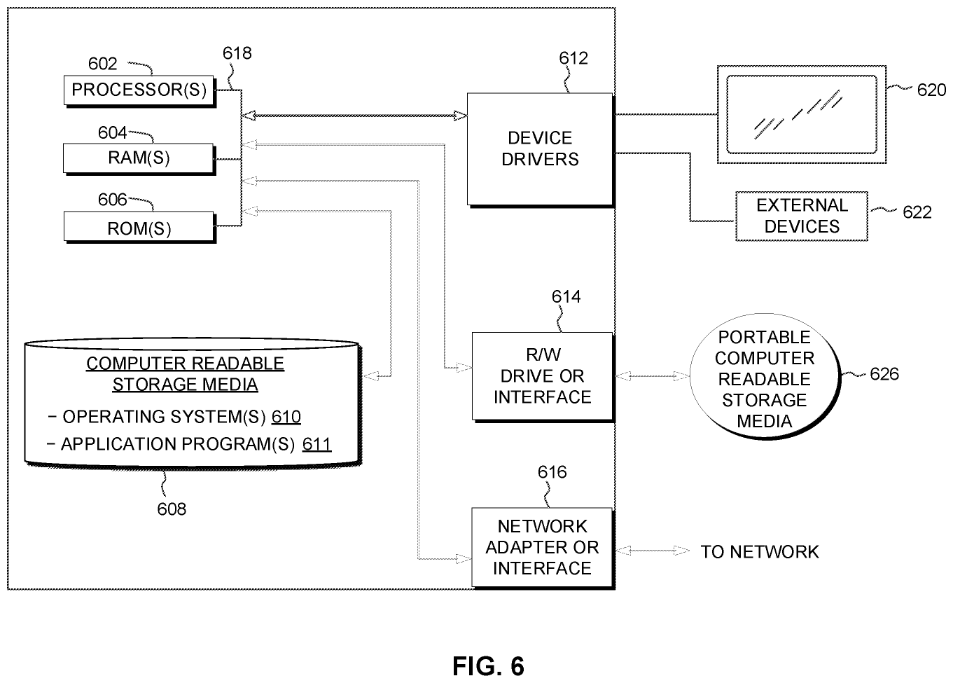

FIG. 6 depicts a block diagram of components of computing devices contained in blackout system 100 of FIG. 1, in accordance with an embodiment. It should be appreciated that FIG. 6 provides only an illustration of one implementation and does not imply any limitations with regard to the environments in which different embodiments may be implemented. Many modifications to the depicted environment may be made.

Computing devices may include one or more processors 602, one or more computer-readable RAMs 604, one or more computer-readable ROMs 606, one or more computer readable storage media 608, device drivers 612, read/write drive or interface 614, network adapter or interface 616, all interconnected over a communications fabric 618. Communications fabric 618 may be implemented with any architecture designed for passing data and/or control information between processors (such as microprocessors, communications and network processors, etc.), system memory, peripheral devices, and any other hardware components within a system.

One or more operating systems 610, and one or more application programs 611, for example, payment application 142, are stored on one or more of the computer readable storage media 608 for execution by one or more of the processors 602 and by utilizing one or more of the respective RAMs 604 (which typically include cache memory). In the illustrated embodiment, each of the computer readable storage media 608 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing devices may also include a R/W drive or interface 614 to read from and write to one or more portable computer readable storage media 626. Application programs 611 on the computing devices may be stored on one or more of the portable computer readable storage media 626, read via the respective R/W drive or interface 614 and loaded into the respective computer readable storage media 608.

Computing devices may also include a network adapter or interface 616, such as a TCP/IP adapter card or wireless communication adapter (such as a 4G wireless communication adapter using OFDMA technology). Application programs 611 on the computing devices may be downloaded to the computing devices from an external computer or external storage device via a network (for example, the Internet, a local area network or other wide area network or wireless network) and network adapter or interface 616. From the network adapter or interface 616, the programs may be loaded onto computer readable storage media 608. The network may comprise copper wires, optical fibers, wireless transmission, routers, firewalls, switches, gateway computers and/or edge servers.

Computing devices may also include a display screen 620, and external devices 622, which may include, for example a keyboard, a computer mouse and/or touchpad. Device drivers 612 interface to display screen 620 for imaging, to external devices 622, and/or to display screen 620 for pressure sensing of alphanumeric character entry and user selections. The device drivers 612, R/W drive or interface 614 and network adapter or interface 616 may comprise hardware and software (stored on computer readable storage media 608 and/or ROM 606).

The programs described herein are identified based upon the application for which they are implemented in a specific embodiment. However, it should be appreciated that any particular program nomenclature herein is used merely for convenience, and thus the disclosure should not be limited to use solely in any specific application identified and/or implied by such nomenclature.

Based on the foregoing, a computer system, method, and computer program product have been disclosed. However, numerous modifications and substitutions can be made without deviating from the scope of the present disclosure. Therefore, the various embodiments have been disclosed by way of example and not limitation.

Various embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer system, comprising:
one or more computer-readable memories storing program instructions; and
one or more processors configured to execute the program instructions to cause the system to perform operations comprising:
detecting, by a server application, a purchase of a first product by a user;
in response to the detecting of the purchase, accessing, by a blackout application, a product-category mapping at a database;
determining a category of the first product based on the product-category mapping;
based on the category of the first product and a model, determining, by the blackout application, a first blackout time period for the user based on a maximum revenue impact amount corresponding to the first blackout time period, a probability that the first product will be repurchased, and a probability that the first product is purchased after a first impression associated with the first product is viewed;
transmitting, by the blackout application to the server application, a message causing the server application to apply the first blackout time period for the user, wherein applying the first blackout time period includes refraining from presenting further impressions associated with the first product for a duration of the first blackout time period; and
in response to determining the first blackout time period for the user has elapsed, presenting, by the server application, a second impression associated with the first product to the user.

2. The computer system of claim 1, wherein the maximum revenue impact amount is received from an administrator.

3. The computer system of claim 1, the operations further comprising causing, by the blackout application, the first blackout time period to be applied, to the user, for a second product corresponding to the category of the first product.

4. The computer system of claim 1, wherein the determining the first blackout time period for the user is further based on a number of products that correspond to the category of the first product.

5. The computer system of claim 1, wherein the probability that the first product will be repurchased and the probability that the first product is purchased after the first impression is viewed is determined based on analyzing historical impression and purchase information corresponding to the first product.

6. The computer system of claim 1, wherein the determining the first blackout time period for the user is further based on a probability that an impression for the first product has been provided to the user.

7. The computer system of claim 3, the operations further comprising:
in response to the detecting the purchase of the first product by the user and the determining the category of the first product:
determining, by the blackout application, a second blackout time period for the user based on the model, the maximum revenue impact amount, a probability that the second product will be repurchased, and a probability that the second product is purchased after an impression associated with the second product is viewed, and wherein the second blackout time period corresponds to a time period where one or more impressions of the second product are not transmitted for display to the user; and
causing the second blackout time period to be applied to the user.

8. A non-transitory computer-readable medium storing computer-executable instructions, that in response to execution by one or more hardware processors, causes the one or more hardware processors to perform operations comprising:
detecting, by a server application, a purchase of a first product by a user;
in response to the detecting a of the purchase, accessing, by a blackout application, a product-category mapping at a database;
determining a category of the first product based on the product-category mapping;
based on the category of the first product and a model, determining, by the blackout application, a first blackout time period for the user based on a maximum revenue impact amount corresponding to the first blackout time period, a probability that the first product will be repurchased, and a probability that the first product is purchased after a first impression associated with the first product is viewed;
transmitting, by the blackout application to the server application, a message causing the server application to apply the first blackout time period for the user, wherein applying the first blackout time period includes refraining from presenting further impressions associated with the first product for a duration of the first blackout time period; and
in response to determining the first blackout time period for the user has elapsed, presenting, by the server application, a second impression associated with the first product to the user.

9. The non-transitory computer-readable medium of claim 8, wherein the maximum revenue impact amount is received by an administrator.

10. The non-transitory computer-readable medium of claim 8, the operations further comprising causing, by the blackout application, the first blackout time period to be applied, to the user, for a second product corresponding to the category of the first product.

11. The non-transitory computer-readable medium of claim 10, wherein the causing the first blackout time period to be applied, to the user, for the second product is based on determining that a similarity coefficient corresponding to the first product and second product is above a threshold level.

12. The non-transitory computer-readable medium of claim 8, wherein the probability that the first product will be repurchased and the probability that the first product is purchased after the first impression is viewed is determined based on analyzing historical impression and purchase information corresponding to the first product.

13. The non-transitory computer-readable medium of claim 8, wherein the determining the first blackout time period for the user is further based on a probability that an impression for the first product has been provided to the user.

14. The non-transitory computer-readable medium of claim 10, the operations further comprising:
in response to the detecting the purchase of the first product by the user and the determining the category of the first product:
determining, by the blackout application, a second blackout time period for the user based on the model, the maximum revenue impact amount, a probability that the second product will be repurchased, a probability that the second product is purchased after an impression associated with the second product is viewed, and a number of products that correspond to the category of the first product, and wherein the second blackout time period corresponds to a time period where one or more impressions of the second product are not transmitted for display to the user; and
in response to determining the second blackout time period for the user, causing the second blackout time period to be applied to the user.

15. A method, comprising:
detecting, by a server application of a computer system, a purchase of a first product by a user;
in response to the detecting of the purchase, accessing, by a blackout application of the computer system, a product-category mapping at a database;
determining a category of the first product based on the product-category mapping;
based the category of the first product and a model, determining, by the blackout application, a first blackout time period for the user based on a maximum revenue impact amount corresponding to the first blackout time period, a probability that the first product will be repurchased, a probability that the first product is purchased after a first impression associated with the first product is viewed, and a probability that an impression for the first product has been provided to the user;
transmitting, by the blackout application to the server application, a message causing the server application to apply the first blackout time period for the user, wherein applying the first blackout time period includes refraining from presenting further impressions associated with the first product for a duration of the first blackout time period; and
in response to determining the first blackout time period for the user has elapsed, presenting, by the server application, a second impression associated with the first product to the user.

16. The method of claim 15, further comprising causing, by the blackout application, the first blackout time period to be applied, to the user, for a second product corresponding to the category of the first product.

17. The method of claim 16, wherein the causing the first blackout time period to be applied, to the user, for the second product is based on determining that a similarity coefficient corresponding to the first product and second product is above a threshold level.

18. The method of claim 15, wherein the determining the first blackout time period for the user is further based on a number of products that correspond to the category of the first product.

19. The method of claim 15, wherein the probability that the first product will be repurchased and the probability that the first product is purchased after the first impression is viewed is determined based on analyzing historical impression and purchase information corresponding to the first product.

20. The method of claim 16, further comprising:
in response to the detecting the purchase of the first product by the user and the determining the category of the first product:
determining, by the blackout application, a second blackout time period for the user based on the model, the maximum revenue impact amount, a probability that the second product will be repurchased, a probability that the second product is purchased after an impression associated with the second product is viewed, and a probability that an impression for the second product has been provided to the user, and wherein the second blackout time period corresponds to a time period where one or more impressions of the second product are not transmitted for display to the user; and
in response to determining the second blackout time period for the user, causing, by the computer system, the second blackout time period to be applied to the user.
